(19) United States
(12) Patent Application Publication
(10) Pub. No.: US 2003/0174943 A1
(43) Pub. Date: Sep. 18, 2003

(54) Optical devices and methods of manufacture

(76) Inventors: Stephen J. Caracci, Corning, NY (US); Adam J. Fusco, Painted Post, NY (US); Cheng-Chung Li, Painted Post, NY (US); Nagaraja Shashidhar, Painted Post, NY (US)

Correspondence Address: CORNING INCORPORATED, SP-TI-3-1, CORNING, NY, 14831

(21) Appl. No.: 10/202,513

(22) Filed: Jul. 23, 2002

Related U.S. Application Data
(60) Provisional application No. 60/364,470, filed on Mar. 14, 2002.

(51) Int. Cl. G02B 6/32

(52) U.S. Cl. 385/33; 385/137

(57) ABSTRACT

Articles and methods for positioning lensed fiber elements and optical devices are disclosed. The articles and methods include a lens gripping element and a fiber gripping element disposed on a planar substrate. The articles and methods are useful for manufacturing optical fiber and lens arrays and waveguide devices.

### RELATED APPLICATIONS

This application claims the benefit of U. S. provisional patent application No. 60/364,470, filed on Mar. 14, 2002.

### FIELD OF THE INVENTION

This invention relates to optical devices and methods of manufacture. More particularly, the invention pertains to devices and methods of making such devices in which a plurality of tensed fibers are arranged in a curvilinear pattern.

### BACKGROUND OF THE INVENTION

Optical fiber and lens arrays are used to couple light between optical fibers and optical devices in optical communication systems. Conventional optical fiber and lens arrays typically include an array of fibers arranged in a silicon v-groove positioning element, and the fiber ends are abutted to a lens array, which can be molded from an appropriate polymeric material. One limitation of this type of fiber and lens array is that since the lenses and fibers are separate elements, it is difficult to optimally align the core region of the optical fiber with the lens, which results in insertion loss.

Lensed optical fibers are devices that include a fiber having a lens formed on the end of the fiber. The assignee of the present invention manufactures lensed fibers under the OptiFocu™ product line, which includes lensed fibers for collimating, focusing, imaging and condensing light. One type of OptiFocus™ lensed optical fiber includes monolithic devices that comprise a lens having a lens end portion attached to an end portion of a fiber. Some lensed fibers include a neck portion surrounding and end portion of the fiber, and the diameter of the neck portion of the lens is greater than the diameter of the fiber.

Examples of specific types of lensed fibers include, but are not limited to, collimating tensed fibers, focusing lensed fibers and tapered tensed fibers. Collimating lensed fibers are up to four times smaller than typical fiber-lens devices, and lensed fibers do not require any alignment of the lens to the fiber. Focusing lensed fibers are capable of focusing light beam sizes down to about six microns, with long working distances. Tapered lensed fibers include a high precision, tapered lens for high numerical aperture applications with short working distances.

To take advantage of the desirable performance characteristics of lensed optical fibers, methods and apparatus are needed to precisely align lensed optical fibers to form an array. One available technology is silicon V-grooves, which are used as fiber positioning elements. V-grooves are formed in a pair of upper and lower silicon substrates and fibers are placed in these grooves. The upper and lower substrates sandwich the fibers and hold the fibers in the grooves. However, V-groove devices have several limitations. For example, once a V-groove is fabricated, it serves to position the optical fiber only relative to the silicon substrate. The end of the fiber, which includes the lens, must still be positioned relative to other optical elements in the system. Such positioning is usually accomplished by micromanipulation and use of adhesives after micropositioning, which is expensive and time-consuming, especially in a mass production manufacturing environment. Another limitation of V-grooves for positioning lensed fibers is that the V-groove is sized to hold the fiber, but the V-groove is too small to hold the lens portion of the lensed fiber. An alignment method and apparatus is needed to hold both the fiber portion and the lens portion of the lensed fiber in position.

It would be desirable to provide alignment methods and apparatus for lensed optical fibers capable of aligning both the fiber portion of the lensed optical fiber and the lens portion of the fiber. Furthermore, there is a need to provide alignment methods and apparatus that do not require adhesives or thermal heat treatments and do not require complex manufacturing steps or elaborate micromanipulation to achieve alignment of the lensed optical fibers. Such alignment methods and articles would facilitate the manufacture of a wide variety of optical devices.

### SUMMARY

Various embodiments of the invention relate to methods and articles for positioning arrays of lensed optical fibers and optical devices including such arrays. The present invention provides relatively simple and inexpensive methods for positioning lensed optical fiber elements and articles including lensed optical fiber elements arranged in curvilinear arrays. The methods and articles do not require adhesives or expensive micropositioning of the fibers. In addition, the methods and apparatus can precisely position and hold both the lens portion and the fiber portion of lensed optical fibers.

It is to be understood that both the foregoing general description and the following detailed description are exemplary and are intended to provide further explanation of the invention as claimed.

### BRIEF DESCRIPTION OF THE DRAWINGS

FIG. 1 is a side view of a substrate including fiber and lens gripping elements holding a lensed fiber;

FIG. 2 is an edge view of a gripping element;

FIG. 3 is an edge view of a gripping element including an optical fiber disposed between a groove of the gripping element;

FIG. 4 is a top view of an optical device including an array of lensed fibers circularly arranged around an optical device; and

FIG. 5 is a top view of an optical device including an array of lensed fibers arranged in a semi-circle around an optical element.

### DETAILED DESCRIPTION

Before describing several exemplary embodiments of the invention, it is to be understood that the invention is not limited to the details of construction or process steps set forth in the following description. The invention is capable of other embodiments and of being practiced or carried out in various ways.

The various embodiments of the present invention provide methods and articles for positioning lensed fibers in arrays. As used herein, the term “lensed fiber” refers to an optical fiber that includes a lens formed on at least one end of a fiber. In certain embodiments, the lens includes generally cylindrical neck portion integrally attached to or surrounding an end portion of the fiber and a lens portion or lens surface. The lens portion or lens surface can be a variety of shapes, but in preferred embodiments, the lens surface is convex-shaped. The methods and articles of the present invention are useful for making optical waveguide devices includes arrays of optical fibers and other optical elements that include but are not limited to prisms, switches, waveguides, filters and polarizers. The positioning elements for the lenses and the fibers and other optical elements can all be arranged on a common substrate.

U.S. Pat. Nos. 6,266,472 and 5,359,687, both of which are incorporated herein by reference, describe polymer microstructures and methods of manufacturing such microstructures for gripping optical fibers. In U.S. Pat. No. 5,359,687, the polymer microstructures formed on a substrate are used to grip optical fibers and position these fibers with respect to a waveguide disposed on the substrate. U.S. Pat. No. 6,266,472 discloses polymer gripping elements that are used in splicing optical fibers.

While the gripping devices disclosed in U.S. Pat. Nos. 5,359,687 and 6,266,472 are suitable for gripping optical fibers not physically connected to any other elements, lensed fibers require further stabilization to securely hold and align the lens portion of a lensed fiber. The various embodiments of the present provide means for holding and precisely aligning both the fiber portion and the lens portion of individual lensed fibers in arrays, enabling the production of a wide variety of optical devices.

Certain embodiments of the invention relate to articles for positioning a plurality of lensed optical fibers, wherein each lensed optical fiber has an optical fiber portion and a lens portion. In some embodiments, the article includes a plurality of fiber gripping elements on arranged in a curvilinear pattern on a substrate, each gripping element including a pair of elastomeric side walls defining a groove therebetween sized to hold the optical fiber portion of the lensed optical fiber. In some embodiments, the article further includes a plurality of lens gripping elements arranged in a curvilinear pattern on the substrate, each lens gripping element including a pair of elastomeric side walls defining a groove therebetween sized to hold the lens portion of the lensed optical fiber.

In certain embodiments, the lens portion further includes a neck portion and a convex-shaped end portion and the lens gripping element is sized to hold the neck portion. According to some embodiments, the elastomeric sidewalls of the lens gripping element and the fiber gripping element are comprised of a polymer. The curvilinear pattern may include a variety of patterns including, but not limited to a semicircle and a circle.

According to some embodiments, each of the lensed optical fibers includes an optical path and the article further includes an optical element disposed in at least one of the optical paths of the lensed optical fibers. Suitable optical elements include, but are not limited to, a MEMs mirror, a liquid crystal switch, an electroholographic switch, a prism a polarizer, a switch, a modulator and an attenuator.

Other embodiments of the invention relate to methods of positioning a plurality of lensed fibers, each lensed fiber including a lens portion and a fiber portion. In certain embodiments, the method includes disposing a plurality of fiber gripping elements in a curvilinear pattern on a substrate, each fiber gripping element including a pair of elastomeric side walls defining a groove therebetween sized to hold the optical fiber portion of the lensed optical fiber. In some embodiments, the method further includes disposing a plurality of lens gripping elements in a curvilinear pattern on the substrate, each lens gripping element including a pair of elastomeric side walls defining a groove therebetween sized to hold the lens portion of the lensed optical fiber. According to some embodiments, the method includes positioning the fiber portions of the lensed fiber within the fiber gripping elements and positioning lens portions of the lensed fiber within the lens gripping elements. According to certain method embodiments, each of the optical fibers includes an optical path for transmitting light and the method further includes disposing an optical element in the optical paths.

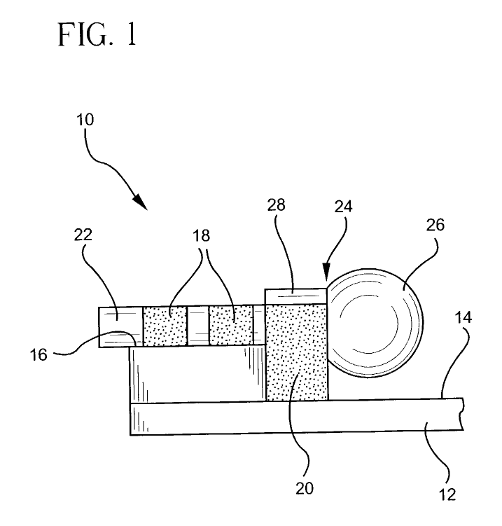

Construction of articles according to certain embodiments of the invention will be described with reference to FIG. 1. A fiber and lens gripping article 10 is shown and includes a substrate 12. The substrate 12 can be made from a variety of materials including but not limited to glass, silicon, ceramics and plastics. The substrate 12 preferably includes a stepped feature including a lower surface 14 and an upper surface 16. Preferably, the upper surface 16 and the lower surface 16 are planar surfaces. At least one fiber gripping element 18, and preferably a plurality of fiber gripping elements 18 are positioned on the upper surface 16 of the substrate 12. At least one lens gripping element 20, and preferably a plurality of lens gripping elements are provided on the lower surface 14 of the substrate. The lens griping element 20 and the fiber gripping element 18 are preferably arranged collinearly on the substrate 12.

The fiber gripping elements 18 are sized to firmly hold an optical fiber 22 in position on the substrate. The lens gripping elements 20 are sized to firmly hold a lens 24 in place on the substrate. Preferably, the lens 24 includes a convex shaped portion or surface 26 and a neck portion 28 and is integrally formed on an end of the optical fiber 22. It will be understood, however, that the shaped of the lens does not have to be convex and other lens shapes are within the scope of the invention. The neck portion 28 of the lens has a diameter that is greater than the diameter of the optical fiber lens. The step feature on the substrate 12 provides the upper surface 16 for the fiber to rest on. The lower surface 14 provides a surface for the lens neck to rest on. The upper surface 16 can be made from the same material as the lower surface 14. Steps can be formed on the substrate by removing a portion of the lower surface 12 of the substrate by techniques including but not limited to grinding or etching such as reactive ion etching. Alternatively, steps can be provided by laminating, injection molding, lithography or printing the step to provide an upper surface 16 on the substrate 12. If the step and upper surface are provided in this manner, the step and upper surface 16 may be made from a material that is different than the material that makes up the lower surface 14.

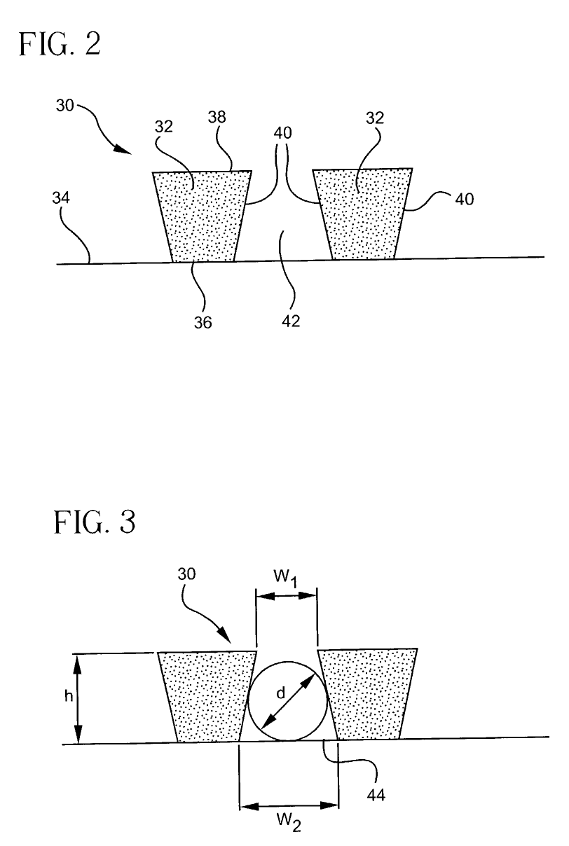

FIG. 2 shows a gripping element 30 in more detail, and it will be understood that the details of the gripping element shown in FIG. 2 pertain to fiber gripping elements and lens gripping elements, except for the differences noted below. The gripping element 30 includes laterally spaced elastomeric strips 32 attached to the surface of a substrate 34. Each of the elastomeric strips has a base portion 36 attached to a surface of the substrate 34, a top surface 38 which is preferably substantially parallel with the surface of the substrate 34 and side walls 40 which provide a groove 42 between the strips 32. A portion of the substrate 34 forms a floor of the groove 42.

Referring now to FIG. 3, a portion of the substrate surface forms a floor 44 for the gripping element so that the groove has a width near the floor w₂ that is greater than the width w₁ at the top of the groove. Preferably, to adequately grip the surface of a fiber or a neck area of a lens, the width w₁ at the top of the groove is less than the diameter d of the fiber or the neck area of the lens. The width w₂ at the bottom of the groove is preferably greater than the diameter d of the lens neck or the fiber. It will be understood that fibers having a larger diameter, for example coated fibers versus uncoated fiber, will require a larger groove to accept insertion of the fiber and to hold the fiber in place vertically and horizontally along its axis. In addition, the neck area of the lens will generally have a larger diameter than the fiber, and therefore the lens grippers will generally have a larger groove width than the fiber grippers. The sidewalls of each strip should be sufficiently flat so that each strip contacts the fiber or neck portion of the lens at least at one point so that the gripper exerts a force on the fiber or lens neck generally perpendicular to the fiber axis. U.S. Pat. No. 5,359,687 contains additional details on particular dimensions for common telecommunications fibers.

The strips that make up the gripping elements are formed using well-known lithographic processes using photopolymerizable compositions and the like. For example, a photopolymerizable composition can be substantially uniformly deposited on onto a substrate surface. The photopolymerizable composition is then imagewise exposed to actinic radiation using a laser and a computer-controlled stage to expose precise areas of the composition with an ultraviolet laser beam, or a collimated UV lamp together with a photomask having a pattern of substantially transparent and substantially opaque areas. The nonimaged areas can then be removed with solvent, while leaving the imaged areas in the form of at least one gripping element on the substrate surface.

Alternatively, elastomeric strips can be formed by using a soft, flexible embossing tool to pattern the polymerizable composition in the form of at least one gripping element on the substrate surface. Such soft tooling is commonly made with silicones. The composition is then cured and the tool is removed. The flexibility of the tool must be sufficient so that it can be removed from the cured polymer without damaging the grippers. The polymerizable composition may be cured by various means such as actinic radiation or heat, and should have the viscosity to conform to the raised features of the tool. After removing the tool from the cured composition, at least one gripping element will remain on the substrate, depending on the nature of the pattern. The pattern of the tool may include a plurality of gripping elements to provide a substrate for aligning an array of fiber and lenses. Suitable polymeric compositions for making the gripping elements are disclosed in commonly assigned U.S. Pat. No. 6,266,472.

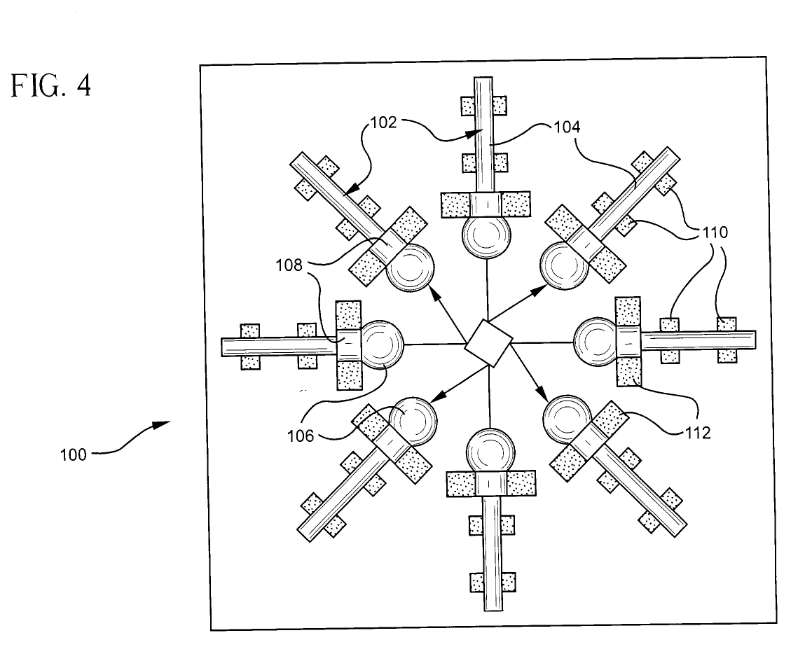

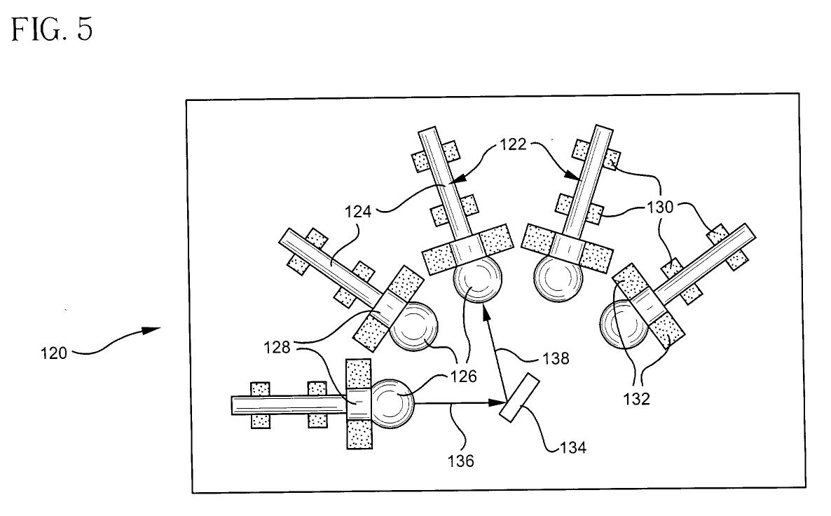

Referring now to FIGS. 4 and 5, the lensed fibers can be placed in a curvilinear pattern, for example, in a circular or semicircular array. In FIG. 4, an optical device 100 includes an array of lensed optical fibers 102, each of the lensed fibers 102 including a fiber portion 104 and a lens that includes a lens surface 106 and a neck portion 108. Fiber gripping elements 110 and lens gripping elements 112 are arranged on the surface of a substrate in the desired curvilinear pattern. After the gripping elements 110 and 112 are arranged in the selected pattern, the fibers and lenses are inserted into the gripping elements to provide the array. In FIG. 4, the lensed fibers are arranged in a rotary or circular pattern around an optical element 114, which can be an element for redirecting the direction of light transmitted through the lensed fiber as shown in FIG. 4. The optical element can be mounted to the surface of the substrate with an adhesive. For example, the optical element could be a prism including multiple thin film filters, a microelectromechanical (MEMs) mirror, an electroholographic grating material, or a liquid crystal switch for redirecting the direction of the transmitted light. The device shown in FIG. 4 can function as a router or a switch.

In FIG. 5, another embodiment of an optical device 120 is shown, which includes a plurality of lensed optical fibers 122 including fiber portions 124 and lens portions that include a lens surfaces 126 and a neck portions 128. Fiber gripping elements 130 and lens gripping elements 132 hold the lensed fibers in the desired configuration. In FIG. 5, an optical element 134 is disposed in the light path of the lensed optical fibers 122. The optical element can be a switching element such as a MEMS switch, an electroholographic switch or a LCD switch, which can redirect light from individual fibers to other fibers in the array as shown by the arrows 136 and 138.

One example of a process for manufacturing optical devices as shown in FIGS. 4 and 5 includes forming a multistep substrate with an embossing tool or by removing portions of a substrate by techniques such as etching or grinding. The substrate surfaces on which gripping elements are formed are prepared with an adhesion promoter to enhance bonding of the gripping elements to the substrate surface. The gripping elements are formed on the surfaces of the substrate with an embossing tool or photomask and cured with actinic radiation or heat as described in U.S. Pat. No. 6,266,472. The gripping elements should be flexible enough to provide enough elastic strength to deform under applied stress when the fibers of lens necks are inserted into the grooves of the gripping elements. A slot is then provided in the substrate by using a saw or laser. A filter, a mirror, an attenuator, a modulator, a grating, a polarizer, a switch such as a liquid crystal switch or other optical device is placed in the slot and held in place by an adhesive. If a switching element such as a liquid crystal switch is used as the optical element, the light passing from one array of optical fibers can divert a signal beam from one individual fibers in one array to a fiber in the other array that is not collinear or in line with the fiber in the other array. Lensed optical fibers are then inserted into the gripping elements to form an array of fibers. The fibers are inserted in the fiber gripping elements and the lens neck portions are inserted in the lens gripping elements.

Another advantage of using elastomeric gripping elements to position lensed fibers in an array is that a wide variety of array configurations can be provided. For example, by using the gripping elements of the present invention, lensed fiber arrays can be arranged in a curvilinear manner, such as in a circular, semicircular array, parabolic and arrays of other shapes. Silicon v-groove technology limits the number of configurations that can be used to position fibers and fiber and lenses in an array because silicon v-grooves are constrained by the crystallographic planes of the material to achieve the v-shaped grooves in a silicon substrate. The v-grooves can only be formed in a parallel configuration. The gripping elements of the present invention allows for greater flexibility in providing a wider variety of fiber arrangements.

It will be apparent to those skilled in the art that various modifications and variations can be made to the present invention without departing from the spirit or scope of the invention. Thus, it is intended that the present invention cover modifications and variations of this invention provided they come within the scope of the appended claims and their equivalents.

What is claimed is:

1. An article for positioning a plurality of lensed optical fibers, each lensed optical fiber including an optical fiber portion and a lens portion comprising:
a plurality of fiber gripping elements arranged in a curvilinear pattern on a substrate, each gripping element including a pair of elastomeric side walls defining a groove therebetween sized to hold the optical fiber portion of the lensed optical fiber; and
a plurality of lens gripping elements arranged in a curvilinear pattern on the substrate, each lens gripping element including a pair of elastomeric side walls defining a groove therebetween sized to hold the lens portion of the lensed optical fiber.

2. The article of claim 1, wherein the lens portion further includes a neck portion and a convex-shaped end portion and the lens gripping element is sized to hold the neck portion.

3. The article of claim 1, wherein the elastomeric sidewalls of the lens gripping element and the fiber gripping element are comprised of a polymer.

4. The article of claim 3, wherein the sidewalls of the lens gripping element are generally parallel and the sidewalls of the fiber gripping element are generally parallel.

5. The article of claim 1, wherein the curvilinear pattern includes a semicircle.

6. The article of claim 1, wherein the curvilinear pattern includes a circle.

7. The article of claim 1, wherein each of the lensed optical fibers includes an optical path and the article further includes an optical element disposed in at least one of the optical paths of the lensed optical fibers.

8. The article of claim 7, wherein the optical element is selected from a MEMs mirror, a liquid crystal switch, an electroholographic switch, a prism a polarizer, a switch, a modulator and an attenuator.

9. A method of positioning a plurality of lensed fibers, each lensed fiber including a lens portion and a fiber portion comprising:
disposing a plurality of fiber gripping elements in a curvilinear pattern on a substrate, each fiber gripping element including a pair of elastomeric side walls defining a groove therebetween sized to hold the optical fiber portion of the lensed optical fiber;
disposing a plurality of lens gripping elements in a curvilinear pattern on the substrate, each lens gripping element including a pair of elastomeric side walls defining a groove therebetween sized to hold the lens portion of the lensed optical fiber; and
positioning the fiber portions of the lensed fiber within the fiber gripping elements and positioning lens portions of the lensed fiber within the lens gripping elements.

10. The method of claim 9, wherein the lens portions further include neck portions and convex-shaped end portions and the neck portions are positioned within the lens gripping elements.

11. The method of claim 9, wherein the curvilinear pattern includes a semicircle.

12. The method of claim 9, wherein each of the optical fibers includes an optical path for transmitting light and the method further comprises disposing an optical element in the optical paths.

13. The method of claim 12, wherein the optical element includes an optical filter.

14. The method of claim 12, wherein the optical element is selected from the group consisting of a MEMs mirror, a liquid crystal switch, an electroholographic switch, a prism a polarizer, a switch, a modulator and an attenuator.

15. An optical device comprising a plurality of lensed optical fibers arranged on a substrate, the lensed fibers including lens portions and fiber portions, wherein the lens portions are arranged in a curvilinear pattern.

16. The optical device of claim 15, wherein the lensed optical fibers include a light path directed towards a centrally located optical element.

17. The optical device of claim 15, wherein the optical element is capable of redirecting light between different lensed fibers in the array.

18. The optical device of claim 17, wherein the optical element is selected from the group consisting of a MEMs mirror, a liquid crystal switch, an electroholographic switch, a prism a polarizer, a switch, a modulator and an attenuator.

19. The optical device of claim 15, wherein the lens portions are arranged in a semicircular pattern.

20. The optical device of claim 15, wherein the lens portions are arranged in a circular pattern.

21. The optical device of claim 15, further including a plurality of elastomeric fiber gripping elements on the substrate for holding the fibers in place and a plurality of elastomeric lens gripping elements on the substrate for holding the lens portions in place.
